(19) United States
(12) Patent Application Publication
(10) Pub. No.: US 2020/0365059 A1
(43) Pub. Date: Nov. 19, 2020

(54) See Them - Self Card

(71) Applicant: Walter Lancaster, Los Angeles, CA (US)

(72) Inventor: Walter Lancaster, Los Angeles, CA (US)

(21) Appl. No.: 16/911,204

(22) Filed: Jun. 24, 2020

(51) Int. Cl. G09F 1/04

(52) U.S. Cl. CPC G09F 1/04; B42D 15/042

(57) ABSTRACT

The present invention is a Fully Reflective Foil Paper Card Stock that can become folded with the Foil Paper Card Stock being able to convey a written or printed or affixed by end-user message upon the one dimensional Adhesive Label Sticker layer cut to selected shape and measurement applied directly upon the resulting one dimensional opposing Fully Reflective internal panel(s) and uniquely herein the present invention is the hybridization of Fully Reflective Foil Paper Card Stock with the purpose of reflecting the image of the end-user recipient with a hightened mental interactive experience for all end-users as with POW the ability to read and, see of “Them Self” unobstructed as specifically and per having previously in preparation been referred to in remark(s) by the end-user generator. To function ?, Needed are only an end-user generator and an end-user recipient.

### FIELD OF INVENTION

This present application of invention of the First Named Inventor herein “Teaches” of a Fully Reflective Foil Paper Card Stock consisting of a one dimension cut to selected shape and measurement then creased at it's central per width or length measurement position point, causing ability to become folded that con become folded consisting of resulting opposing Fully Reflective internal panel(s) with applied a one dimensional Adhesive Label Sticker layer cut to selected shape and measurement applied directly upon the resulting one dimensional opposing internal Fully Reflective Foil Paper Card Stock panel(s), consisting of being able to convey written, or drafted, or affixed, or printed remark(s) upon the one dimensional Adhesive Label Sticker layer cut to selected shape and measurement applied directly upon the resulting one dimensional opposing internal Fully Reflective Foil Paper Card Stock panel(s),

This present application of invention of the First Named Inventor “Walter Lancaster” herein “Teaches” uniquely the hybridization of Adhesive Label Sticker(s) and foil Paper Card Stock with the purpose of reflecting the image of the end-user recipient of “Them-Self”.

### BACKGROUND OF THE INVENTION

Prior art to the present invention is Fully Reflective Foil Paper Card Stock that can become folded with the express intent of Foil Paper Card Stock being able to convey written, or drafted, or affixed, or printed remark(s) by an end-user upon a one dimensional Adhesive Label Sticker layer cut to selected shape and measurement applied directly upon the resulting one dimensional opposing internal Fully Reflective Foil Paper Card Stock panel(s).

Prior art to the present invention is a fully reflective Foil Paper Card Stock that can become folded with the express intent of resulting Foil Paper Card Stock being to convey written, or drafted, or affixed, or printed remark(s) by an end-user message upon a one dimensional Adhesive Label Sticker layer cut to selected shape and measurement applied directly upon the resulting one dimensional opposing internal reflective Foil Paper Card Stock panel(s) and uniquely herein the present invention is the hybridization of fully reflective Foil Paper Card Stock with the purpose of reflecting the image of the recipient such as the Prior Art of an unobstructed Mirror.

The present invention is new, unique and different from all prior art. The present invention now presents a hightened mental experience by means of written, drafted, or affixed remarks fused as hybrid with a highly flexible, highly reflective surface stock resulting in an interactive experience for all end-users as with now the ability read of “Them Self” as specifically and personally in preparation been previously referred to in written, or drafted, or affixed, or printed remark(s).

The present invention herein combines the industry of Greeting, Post, and Business Cards in all forms designed to comport any written, or drafted, or affixed, or printed remark(s), and the industry and the manufacture of highly flexible reflective Foil Paper Card Stock(s) with the effect of a producing a clear reflection.

### BRIEF SUMMARY OF THE INVENTION

The present invention is new, unique and different from all prior art. The present invention now presents a hightened experience by means of written, drafted, or affixed remarks fused as hybrid with a highly flexible, highly reflective surface stock resulting in an interactive experience for all end-users as with now the ability to read of “Them Self” as specifically and personally in preparation been previously referred to in written, or drafted, or affixed, or printed remark(s).

### BRIEF DESCRIPTION OF THE DRAWINGS

FIG. 1 of 5

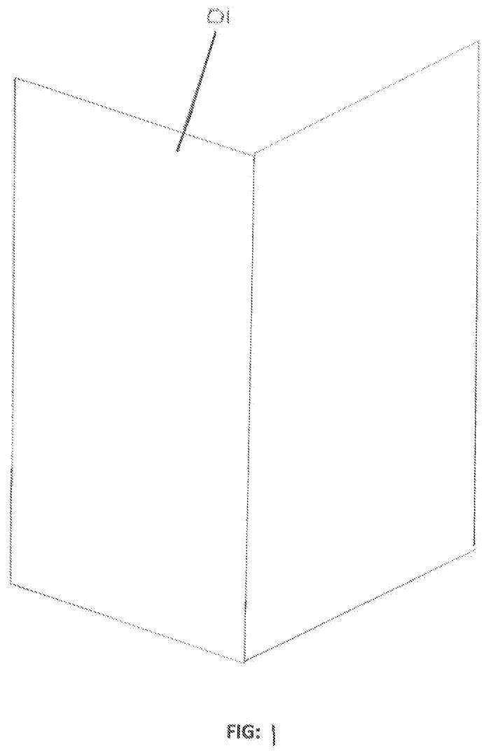

[01] Upper Rear view of the Non-Reflective side of Foil Paper Card Stock of one dimension cut to selected shape and measurement then creased at it's central per width or length measurement position point, causing ability to become folded resulting in opposing Fully Reflective internal panel(s)

FIG. 2 of 5

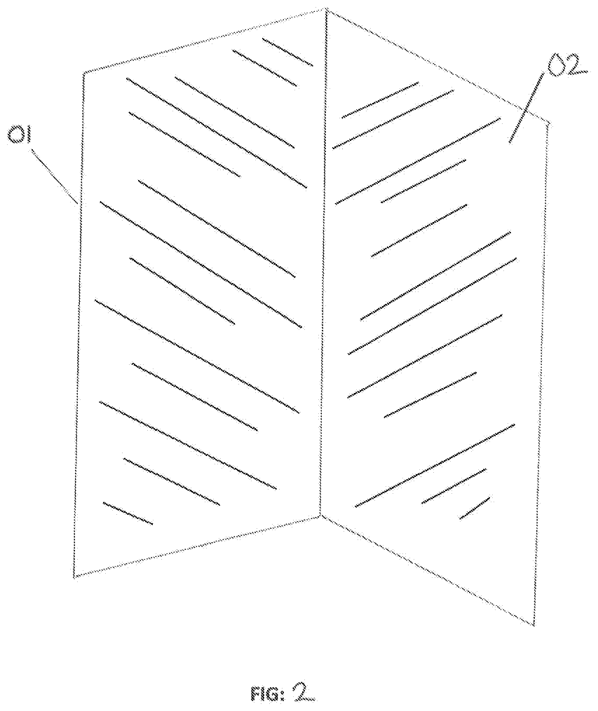

[02] Upper From view of the Fully Reflective side of the Foil Paper Card Stock of one dimension cut to selected shape and measurement then creased at it's central per width or length measurement position point, causing ability to become folded resulting in opposing Fully Reflective internal panel(s).

FIG. 3 of 5

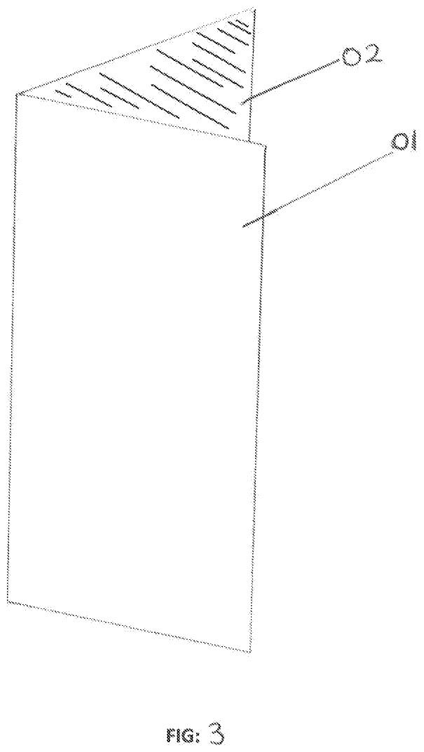

[01] Upper Side view of the Foil Paper Card Stock of one dimension cut to selected shape and measurement then creased at it's central per width or length measurement position point, causing ability to become folded resulting in opposing Fully Reflective internal panel(s).

[02] Fully Reflective Foil Paper Card Stock opposing internal panel(s).

FIG. 4 of 5

[03] Adhesive Label Sticker layer cut to selected shape and measurement.

FIG. 5 of 5

[02] Upper Front Internal view of the of reflective side of Foil Paper Card Stock opposing internal panel(s).

[03] Adhesive Label Sticker layer cut to selected shape and measurement applied directly upon the resulting one dimensional opposing internal Fully Reflective Foil Paper Card Stock panel(s). [02]

### DETAILED DESCRIPTION OF THE INVENTION

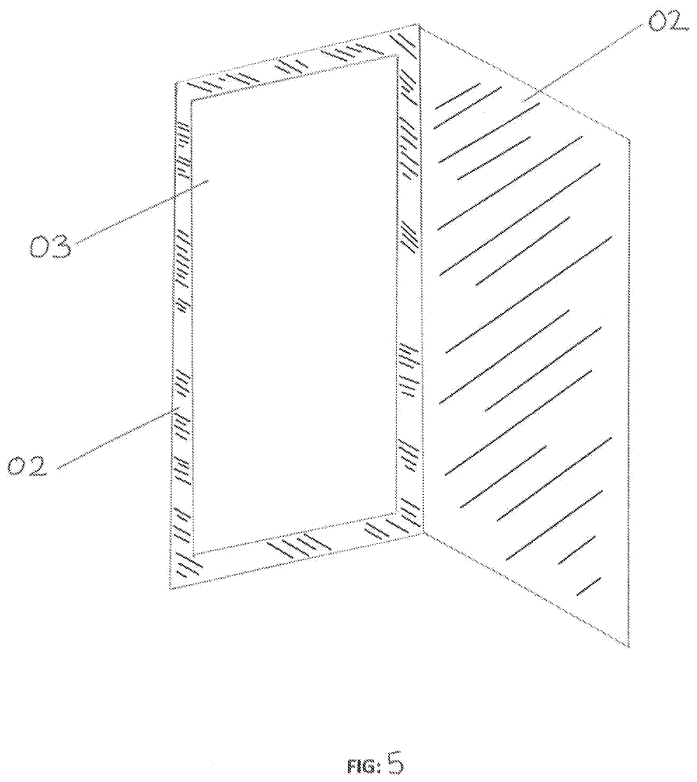

The first named inventor for the present invention herein entitled “The See Them-Self Card” teaches a Greeting. Post, or Business Card [01] with a means to comport a hightened mental experience by means of written, drafted, or affixed remark(s) upon an Adhesive Label Sticker Sheet [04] fused as hybrid with a highly flexible, highly reflective Foil Paper Card Stock [02] resulting in a hightened mental interactive experience for all end-users as with now the ability read of “Them Self” as specifically and personally in preparation been previously referred to in written, or drafted, or affixed, or printed remark(s). [FIG. 5]

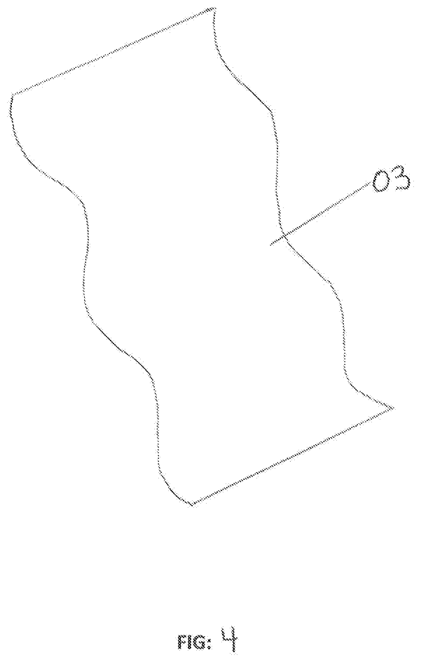

The present invention includes at least the following two basic components:

[FIG. 5] A [01] Foil Paper Card Stock of one dimension cut to selected shape and measurement then creased at it's central per width or length measurement position point, causing ability to become folded resulting in [02] opposing internal panel(s) and;

[FIG. 4] A [03] one dimensional Adhesive Label Sticker layer cut to selected shape and measurement.

The first named inventor for the present invention herein entitled “The See Them-Self Card” is not-complete until [FIG. 5] applied to the [02] Foil Paper Card Stock of one dimension is a one dimensional Adhesive Label Sticker layer cut to selected shape and measurement [03] applied directly upon the resulting one dimensional opposing internal reflective Foil Paper Card Stock panel(s).[02]

1. Claimed herein is the Utility of Foil Paper Card Stock consisting of a one dimension cut to selected shape and measurement then creased at it's central per width or length measurement position point, causing ability to become folded.

2. Claimed herein is the Utility of Foil Paper Card Stock consisting of resulting Fully Reflective opposing internal panel(s).

3. Claimed herein is the Utility of a fully reflective Foil Paper Card Stock consisting of, a one dimensional Adhesive Label Sticker layer cut to selected shape and measurement applied directly upon the resulting one dimensional opposing internal Fully Reflective Foil Paper Card Stock panel(s).
